(19) United States
(12) Patent Application Publication
(10) Pub. No.: US 2006/0185482 A1
(43) Pub. Date: Aug. 24, 2006

(54) Rip fence alignment gauge

(76) Inventor: Brent Joseph Stagnaro, Arlington, VA (US)

Correspondence Address: Brent Stagnaro, 5893 First ST. South, Arlington, VA, 22204, US

(21) Appl. No.: 11/061,609

(22) Filed: Feb. 22, 2005

(51) Int. Cl. B26D 1/00; B26D 7/06

(52) U.S. Cl. 83/13; 83/421; 83/435.11

(57) ABSTRACT

A rip fence alignment gauge located in the guide groove of the work surface of a table saw for positioning the rip fence parallel to the saw blade. The alignment gauge having a measuring rule and an adjustable vise with parallel walls perpendicular to the saw blade to hold the measuring rule in a fixed position all located upon a base. Beneath the base and secured to the base is an elongated bar which is able to be set within the opening of the guide groove of the working surface of the table saw and has the ability to adjust to equal the exact width of the varying widths of different manufactured guide grooves. The invention also includes an apparatus which is able to be attached to the measuring rule allowing the user to locate and relocate the exact alignment of a desired distance held between the fence and the saw blade.

### BACKGROUND OF THE INVENTION

This invention relates generally to power tool alignment devices and particularly to precision rip fence gauges for making a fence guard of a table saw parallel to the saw blade. There have been several patents in the past to alleviate the burden of a mis-aligned fence guard.

With respect to U.S. Pat. No. 5,353,515 which has been described as comprising of first and second symmetrical laterally separable gauge half assemblies. Each gauge half assembly is essentially a locator bar connected by screws to an elongated flat rod which is positioned in the guide groove of miter slot allowing the fence guard to become parallel with the saw blade. The two assemblies mentioned in this art must be adjusted independently of one another which is time consuming and allows error to occur in the distance measurement of each locator rod to the fence guard. In addition, the invention is large and cumbersome to a woodworker's ability to place and replace the devise on the table and find an appropriate location to store them until the next fence guard adjustment.

With respect to U.S. Pat. No. 5,207,007 which has been described as being a set-up tool for woodworking equipment consisting of a dial indicator and mounting members which mount the dial indicator in a measuring position above the surface and the indicator is moveable with respect to the mounting member that fits into the miter slot. This art has several short comings with respect to making a fence guard parallel to the saw blade. The indicator tip is not locked into position hence the fence guard has nothing to stop against while the user adjusts the fence placement making the indicator move. Also, this devise is limited with respect to the distance the fence can be away from the saw blade. Finally, this invention does not measure the distance the fence is from the blade only that the two ends of the fence are equal.

With respect to U.S. Pat. No. 4,930,221 which has been described as first and second half section body members mounted in a facing relationship, and racks formed on their facing surfaces with teeth at predetermined equal spaced intervals. These predetermined grooves does not allow flexibility when setting the distance between the fence guard and the saw blade.

The submitted invention takes all of these problems into account with respect to its overall design and has amenities which the previous art does not.

### BRIEF SUMMARY OF THE INVENTION

In general, the invention enables the rip fence to be parallel to the saw blade of a table saw prohibiting mis-aligned cuts to work pieces. The invention clearly accomplishes this basic idea and provides additional amenities for the user. The rip fence alignment gauge presented has adjustable planes with parallel walls set perpendicular to the saw blade which is able to hold and secure in place a linear measuring rule allowing the utmost flexibility with respect to the distance achieved between the saw blade and the rip fence. The adjustable planes are free to move within a groove provided by the design of the base enabling the device to use many different widths of measuring rules if the user so desires and the measuring rule is then able to be securely held into a desired position by a wingnut threaded bolt which is easily released allowing the measuring rule to be quickly relocated to another desired position and then tightened into place again. Since the measuring rule is securely held into position the fence is able to be butted up against the side of the measuring rule without the possibility of the rule moving and losing the desired distance between the fence and the saw blade.

This invention provides additional amenities, one of which, is providing an apparatus to be securely fastened to the linear measuring rule marking a user-defined predetermined distance between the saw blade and fence. The user is able to locate a distance previously used allowing a piece of work to be cut to the exact size as one which was cut before the distance was changed. Another amenity is providing an attachment to the elongated bar which is able to be adjusted to equal the exact width of the user's particular table saw guide groove slot thus making the invention universal to all table saw equipment.

The size of this invention is one which can be easily stored or located on the opposite side of the rip fence while the table saw is in use making for a less cluttered work area and shortening rip fence alignment time.

The principal steps to aligning a rip fence are as follows: Once the measuring rule is held in the desired position, the user would then slide the devise while in the guide groove away from the saw blade and toward the user's end of the table saw and abut the rip fence to the side of the measuring rule. At this time the user would then slightly push down on the locking handle of the rip fence holding that end of the fence in place. The user would pick up the gauge with his other hand and place it at the other end of the table saw in the guide groove and then abut the other end of the rip fence to the measuring rule. At this time the locking handle of the rip fence can be securely tightened and the gauge can then be moved to the other side of the rip fence for storage.

### BRIEF DESCRIPTION OF THE SEVERAL VIEWS OF THE DRAWINGS

FIG. 1 is a schematic plan looking down at the invention.

FIG. 2 is a schematic elevation of the invention.

FIG. 3 is a schematic longitudinal section taken through the center of the invention with the position alignment marker attached to the measuring rule.

FIG. 4 is a schematic cross section taken through the securing component of the invention positioned within the guide groove of an imaginary table saw.

FIG. 5 is a schematic cross section taken through the guide groove equalizing component of the invention positioned within the guide groove of an imaginary table saw.

### DRAWING REFERENCE NUMBERS

1. Base
2. Elongated Flat Rod
3. Movable Vertical Plane
4. Stationary Vertical Plane
5. Measuring Rule
6. Horizontal Plane Guide
7. Movable Horizontal Plane
8. Elongated Bolt Slot
9. Measured Increments
10. Machine Screw
11. Non-slip Surface
12. Imaginary Table Saw Guide Groove
13. Post
14. Opening
15. Flat Plane
16. Position Alignment Marker
17. Machine Screw
18. Wing-Nut
19. Wing-Nut Machine Bolt
20. Position Alignment Groove

### DETAIL DESCRIPTION OF THE INVENTION

Referring to the drawings and the art of the invention in greater detail, Fig.4 and FIG. 5 show the rip fence alignment gauge positioned in the guide groove of an imaginary work surface of a table saw with the use of an elongated flat rod (2) and an adjustable gap equalizer positioned within the elongated flat rod (2) and between the side of the elongated flat rod (2) and the side of the imaginary table saw guide groove (12). The adjustable gap equalizer is comprised of a post (13), flat plane (1 5), and a machine screw (10). In the preferred embodiment the post (13) is cylindrical in shape with a flat surface to receive the flat edge of the machine screw (10) and has an equal diameter to that of the horizontal opening (14) through the elongated flat rod within which the post (13) is able to move. The post (13) is then able to be secured in a desired position with the use of a machine screw (10) located within the elongated flat rod and on center to the diameter of the post (13). Attached and perpendicular to the post (13) is a flat plane (15) which allows the invention, with the push of human force, to move smoothly within the imaginary table saw's guide groove (12). The purpose of the adjustable gap equalizer is to equal the width of the varying widths of different manufactured table saw guide grooves (12).

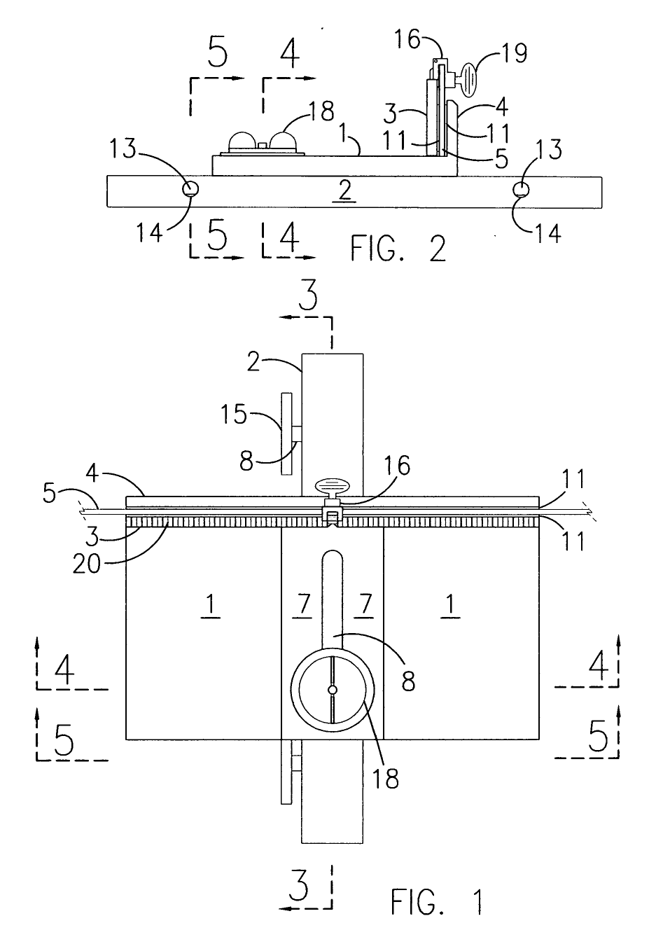

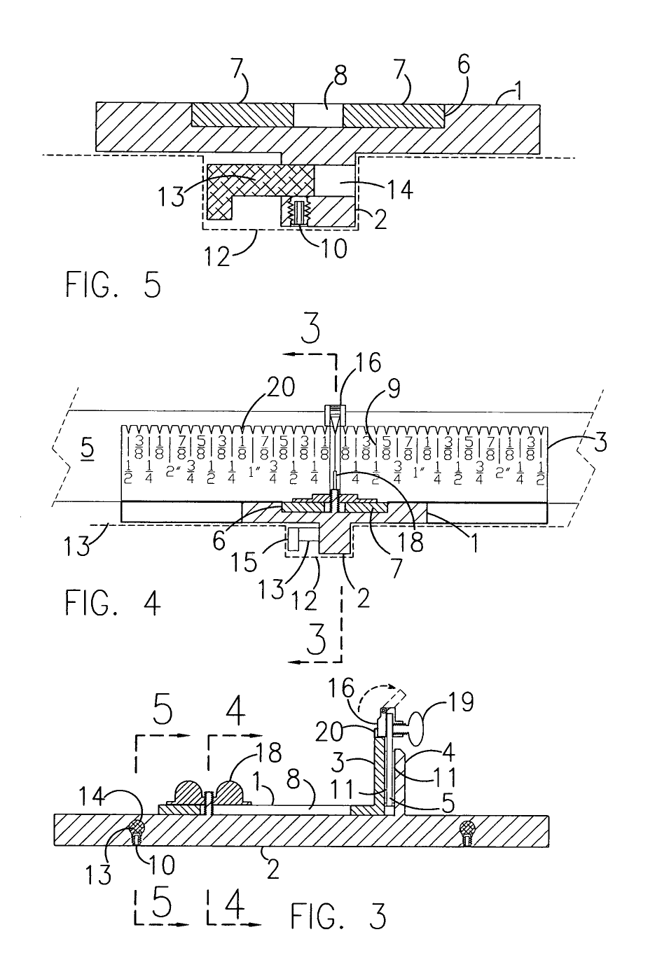

Referring to FIG. 1, FIG. 2 and FIG. 3, attached to and above the elongated flat rod (2) is a base (1) on and within which are located a stationary vertical plane (4), a movable vertical plane (3), a movable horizontal plane (7), a wing-nut (18), and a machine screw (17) all for which to hold in place the measuring rule (5). Within the base (1) is a horizontal plane guide (6) which the movable horizontal plane (7) moves within to allow the movable vertical plane (3 ) to separate from the stationary vertical plane (4) while maintaining the movable vertical plane (3) and the stationary vertical plane (4) parallel to one another.

The movable horizontal plane (7) has an elongated bolt slot (8) above and within which a wing-nut (18) and machine screw (17) are respectively positioned. The user of the invention squeezes together the movable vertical plane (3) and the stationary vertical plane (4), with the measuring rule (5) located between the two, with one hand and tightens the wing-nut (18) onto the machine screw (17) with the other hand. The movable horizontal plane (7) is then secured into a desired position due to the downward pressure applied by the wing-nut (18) thus holding in place the movable vertical plane (3) to which it is attached and in turn securing in place the measuring rule against the side of the stationary vertical plane (4) allowing the rip fence to be butted up against the measuring rule (5) without the rule (5) moving and changing the desired distance of the blade to the rip fence. To ensure that the rule (5) does not move this invention uses a non-slip rubber surface (11) on the inward surface of the movable vertical plane (3) and stationary vertical plane (4). When the wing-nut is unscrewed the pressure is released and the movable horizontal plane (7) is able to move within the horizontal plane guide (6) thus moving the vertical plane (3) and in turn allowing the measuring rule (5) to move between the vertical plane (3) and the side of the stationary vertical plane (4).

At the top of the movable vertical plane (3) are position alignment grooves (20) in which a portion of the alignment marker (16) can be placed so to mark the desired distance a saw blade is from the rip fence. The invention allows for an infinite number of arrangements of distance between the rip fence and saw blade. The preferred embodiment also has alignment grooves (20) in a repetitive distance from one another in order for the user to be able to move and locate the measuring rule (5) against the rip fence at predetermined measured increments (9) insuring a reduction of alignment time while making adjustments to the rip fence as shown in FIG. 4.

An attachable position alignment maker (16) can be secured to the edge of the measuring rule (5) in an infinitely number of positions insuring the greatest flexibility for the user. Referring to FIG. 3, the art of the position alignment marker (16) is such that the portion which is located within an alignment groove (20) can be rotated and can come to rest in a position which allows the measuring rule (5) to be adjusted while the marker is attached to the measuring rule (5) thus giving the ability for the measuring rule (5) to have more than one alignment marker (16) secured to it at the same time insuring many predetermined desired distances between the rip fence and the saw blade for the user. The alignment marker (16) is such that the rotatable proportion is pivoted between two stationary vertical legs which are positioned against the measuring rule (5). The inner portion of the alignment marker (16) is an open channel which surrounds the measuring rule on it's front, top, and rear sides. The alignment marker (16) is able to be secured to the measuring rule (5) with the means of a wing-nut machine bolt (19). The bolt (19) is screwed tight to the back of the measuring rule (5), the force applied pushes the rule (5) against the back side of the horizontal legs of the alignment marker (16) thus holding the marker (16) in place.

The measuring rule is of known and common art to the industry. It is composed of linear metal, wood, plastic, or other material indicating increments of measure.

The material of the parts and components of this invention can be of a variety of materials, such as wood, plastic, metal, or in combination. The wing-nut, machine screw, wing-nut machine bolt are best if they are made from metal since they need to be very strong.

It is to be understood that the form of the invention herein shown and described is to be taken as a preferred example of the same and certain changes in the shape, size, and arrangement of the parts may be made without departing from the spirit of the invention or scope of the subjoined claim.

Having described my invention, I claim as new and desire to secure by patent:

1. A rip fence alignment gauge including a flat rod for which to place into the guide groove of a work surface of a table saw, a base on which resides, a vertical stationary plane, a movable vertical plane, a movable horizontal plane, and a means to secure the vertical stationary plane, movable vertical plane, and movable horizontal plane into position.

2. A rip fence alignment gauge of claim 1 wherein comprising of the means to make the elongated rod universal to the width of all table saw guide grooves.

3. A rip fence alignment gauge of claim 1 wherein comprising incremented grooves.

4. A rip fence alignment gauge of claim 1 wherein comprising a position indicator for which to locate a previous distance between the saw blade and rip fence.

5. The method by which to make parallel a rip fence to a saw blade by abutting the rip fence to a measuring rule secured into position and located in the guide groove of a table saw.

6. The method by which to locate a previously determined distance between the saw blade and rip fence by securing a position marker to a measuring rule.
